(19) United States
(12) Patent Application Publication
(10) Pub. No.: US 2026/0204246 A1
(43) Pub. Date: Jul. 16, 2026

(54) NOISE CANCELLING SPEAKER BULB DEVICE AND SYSTEM

(71) Applicant: Richard Stoerger, New Rochelle, NY (US)

(72) Inventor: Richard Stoerger, New Rochelle, NY (US)

(21) Appl. No.: 19/440,027

(22) Filed: Jan. 5, 2026

Related U.S. Application Data
(63) Continuation-in-part of application No. 18/410,983, filed on Jan. 11, 2024, now Pat. No. 12,542,992.
Application No. 18/410,983 is a continuation-in-part of application No. 17/658,414, filed on Apr. 7, 2022, now Pat. No. 12,020,678.
Application No. 17/658,414 is a continuation-in-part of application No. 17/088,008, filed on Nov. 3, 2020, now Pat. No. 11,330,369.
(60) Provisional application No. 62/930,445, filed on Nov. 4, 2019.

(51) Int. Cl. G10K 11/178; H04R 1/02; H04R 1/32

(52) U.S. Cl. CPC G10K 11/17823; G10K 11/17873; H04R 1/025; H04R 1/323; H04R 1/326; G10K 2210/3027; G10K 2210/3046

(57) ABSTRACT

A noise cancelling speaker bulb device and system features the form factor of a light bulb that attaches directly to lighting fixtures in place of a light bulb(s) that may include one or more noise cancelling speakers and can include a lighting fixture. The speaker system may be mounted or integrated into a floor standing or tabletop fixture (i.e. table lamp), suspended or built into a ceiling or support, or mounted to a wall or other furniture (ceiling lamp). The system is designed to cancel out noise, play music or announcements if desired, and providing lighting if desired. The system may be in communication with external microphones and may be controlled using a control interface, such as a remote control.

### CROSS-REFERENCE TO RELATED APPLICATIONS

This Application is a Continuation-in-Part of U.S. Non-Provisional Ser. No. 18/410,983, titled Noise Cancelling Speaker Device and System, filed on Jan. 11, 2024, now U.S. Pat. No. ______, the contents of which are expressly incorporated herein by this reference as though set forth in their entirety, and to which priority is claimed. U.S. patent application Ser. No. 18/410,982 is a Continuation-in-Part of U.S. Non-Provisional Ser. No. 17/658,414, titled Noise Cancelling Soundbar Device and System, filed on Apr. 7, 2022, now U.S. Pat. No. 12,020,678, the contents of which are expressly incorporated herein by this reference as though set forth in their entirety, and to which priority is claimed. U.S. patent application Ser. No. 17/658,414 is a Continuation-in-Part of U.S. patent application Ser. No. 17/088,008, filed on Nov. 3, 2020, now U.S. Pat. No. 11,330,369, the contents of which are expressly incorporated herein by this reference as though set forth in their entirety, and to which priority is claimed. U.S. Non-Provisional Ser. No. 17/088,008 claims the benefit of U.S. Provisional Ser. No. 62/930,445 , filed on Nov. 4, 2019, the contents of which are expressly incorporated herein by this reference as though set forth in their entirety, and to which priority is claimed.

### FIELD OF USE

The present disclosure relates generally to devices, systems, and methods for electronic loud speakers, and more specifically to a noise cancelling loudspeaker bulb system that creates semi-soundproof zones for its nearby users without requiring the use of headphones or expensive soundproofing insulation. This noise cancelling speaker bulb device and system also enhances the playing of music by reducing background noise and artifacts created during the process of making sound.

### BACKGROUND

Loudspeakers are used in all types of applications. They are used for the public address systems, background music, foreground music in all types of environments and spaces. They are used to project announcements as well as entertainment. In restaurants and bars, the use of loudspeakers for music is commonplace.

Unfortunately, noise is everywhere and often encumbers ones ability to hear others or to be heard when in conversation. This is prevalent in dining establishments among other places, where noise generated by other diners, persons mingling at the bar, kitchen noise and the bustling sounds created by the wait staff to name a few, makes conversation difficult or impossible. One has to strain to hear and to be heard making for a less than desirable dining experience. Additionally speakers used in dining establishments often sound distorted adding to the din rather than helping to solve a problem. In the end patrons find it hard to be heard by the person sitting across the table.

Often there is no way to improve this situation of unwanted background noise. Proper soundproofing of the space can help in this matter as well as spacing the tables or setting up partitions in addition to providing distance between the dining space and the crowded areas such as the bar.

However, as the cost of space is a premium as well as the installation of sound proofing materials, often there is nothing that can be done to improve the noise level at dining table.

This same problem extends to other spaces and environments. You can have too much background noise in the home, in the office, schools, and house's of worship, anywhere.

And often, the desire is not to eliminate the background noise entirely. It is simply to reduce the level of that sound so that conversation can take place without having to yell or strain one's voice while constantly having to focus one's hearing.

Thus, what is needed is a convenient, comfortable, and affordable way for users to comfortably engage with each other without having to shout or move so close as to be inconvenienced and without having to wear headphones with microphones in noisy spaces just to speak with each others (the way persons speak in small noisy aircraft like a helicopter). What is required is a system that reduces the effects of background noise and if desired, enhances the space with sound (music) and light.

### SUMMARY

To minimize the limitations in the cited references, and to minimize other limitations that will become apparent upon reading and understanding the present specification, the present specification discloses a new noise cancelling sound device and system that is ideal for dining establishments but also suitable for other uses were the lowering of the noise level is desired, be it from the speaker playing music, the noise generated in the space or both.

In one embodiment, the noise cancelling speaker bulb device and system of the present disclosure features the form factor of a light bulb that attaches directly to lighting fixtures in place of a light bulb(s) and may comprise one or more loudspeakers, an integrated power amplifier, an audio input communication module, internal or external microphones and a lighting element (optional). The noise cancelling speaker bulb may combine multiple audio-related technologies into a form factor specifically optimized for use in bars and restaurants. This can involve either completely independent self-contained devices, centrally connected devices (wired or wirelessly), or a hybrid of self contained devices that connect to a centralized system for content (music) and noise data (microphones used to measure sound {noise} closer to the noise source).

In one embodiment, the noise cancelling speaker bulb device and system of the present disclosure features the form factor of a light bulb that fits into an Edison E27 lighting fixture (standard diameter threaded light bulb), Edison E14 lighting fixture (small diameter threaded light bulb), GU10 Socket (spotlights), or a clip-on track-light in place of a light bulb(s) and may comprise one or more loudspeakers, an integrated power amplifier, an audio input communication module, internal or external microphones and a lighting element (optional). The noise cancelling speaker bulb may combine multiple audio-related technologies into a form factor specifically optimized for use in bars and restaurants. This can involve either completely independent self-contained devices, centrally connected devices (wired or wirelessly), or a hybrid of self contained devices that connect to a centralized system for content (music) and noise data (microphones used to measure sound {noise} closer to the noise source).

The noise cancelling speaker bulb may be configured to receive an audio signal input from a media source, such as a TV, smartphone, central music system or other device, and play the audio signal from the one or more loudspeakers. The lighting element (optional) can provide light. In one embodiment, the one or more loudspeakers may preferably be adjustable via an actuator, which allows the one or more loudspeakers to be rotated or pivoted to precisely aim the audio output of the noise cancelling speaker bulb. By carefully positioning the noise cancelling speaker bulb and the one or more loudspeakers, it is possible to focus the beneficial noise cancelling affect to listening area as well as direct sound (music) and light to that space such as a dining room table.

For example, it is not uncommon to include table lamps or hanging lamps in restaurants and bars. It is also common to have speakers mounted in the same space for music. The noise cancelling speaker bulb can combine both lighting and sound in one element while at the same time directing noise cancelling sound waves to areas and spaces.

One embodiment may be a noise cancelling speaker bulb system, comprising just a noise cancelling speaker bulb that is hung over a table or bar. In another embodiment, that same enclosure may include a lighting fixture. These noise cancelling speaker bulbs can also be mounted to the ceiling or a structure above the table. They can even be built into a surface so that they appear to be recessed which may include cosmetic variations that make them nearly invisible to the eye.

One or more microphones may be used to measure nearby ambient noise. The measured ambient noise may then be processed by the active noise cancellation module, such that a negative sound output pattern is generated. In one embodiment, any ambient noise in the vicinity of the noise cancelling loud speaker may be measured by the one or more microphones. The noise cancellation module may then communicate with the one or more microphones to obtain accurate ambient noise data present. The noise cancelling speaker bulb may then process the ambient noise data with an active noise cancellation module, to produce a negative sound output pattern that is specifically designed to cancel out the ambient noise emanating from the vicinity of the microphones. The one or more loudspeakers of the noise cancelling speaker bulb may then play the negative sound output pattern, such that the negative sound output pattern destructively interferes with the sound waves of the ambient noise. In this manner, the noise cancelling speaker bulb may insulate a user of the noise cancelling speaker from the ambient noise in the vicinity of the first of the microphones.

The noise cancelling speaker bulb may use the corresponding microphones, active noise cancelling module(s), and loudspeakers to similarly insulate a user from ambient noise while listening to the media from either a centralized audio system or of their choosing from a personal device (such as a mobile device playing music via Bluetooth) to the noise cancelling speaker.

Each noise cancelling speaker bulb may preferably be positioned near a listener's head/ears, reducing the level of sound required for the user to hear the loudspeaker output audio. Suitable locations for placing a noise cancelling speaker may include, for example, bar areas, dining room tables, offices, libraries, home offices, work spaces, bedrooms and play areas.

One embodiment may be a noise cancelling speaker bulb, comprising: one or more loudspeakers, an integrated power amplifier, an audio input communication module, one or more microphones, and an active noise cancelling module; wherein the one or more microphones may be configured to measure ambient noise; wherein the active noise cancelling module may be configured to process the ambient noise, to create a negative output that may be configured to destructively interfere with the ambient noise; wherein the negative output audio may be configured to be emitted from the one or more loudspeakers, such that the ambient noise may be substantially cancelled or reduced, and; wherein the noise cancelling speaker bulb may be configured to receive an audio signal from one or more media sources and subsequently play the audio signal from the one or more loudspeakers. In another embodiment, the noise cancelling speaker bulb may further comprise one or more adjustable bases and one or more actuators; wherein the one or more loudspeakers may be mounted on the one or more adjustable bases; wherein the one or more actuators may be configured to adjust the one or more adjustable bases. The noise cancelling speaker bulb may be installed in any environment with sufficient space, including, but not limited to, the dining space. Preferably, the one or more adjustable bases may be configured to direct the audio output signal from the one or more loudspeakers to a listener by the bar or in a booth.

One embodiment may be a noise cancelling speaker bulb system, comprising: a first noise cancelling speaker and a second noise cancelling speaker, wherein the first and second noise cancelling speakers may each individually comprise, respectively: a first/second set of one or more loudspeakers; a first/second audio input communication module; at least one first/second ambient microphone; at least one first/second near field microphone, and a first/second active noise cancellation module. In a preferred embodiment, the first noise cancelling speaker bulb and the second noise cancelling speaker bulb may be configured to offset each other. At least one first ambient microphone and the at least one second ambient microphone are on different noise canceling speakers. The at least one first near field microphone and the at least one second near field microphone may be proximate to the noise cancelling speaker bulb, and be configured to, respectively, measure a first and second near field noises coming from another table, wherein the at least one ambient microphone and the at least one second ambient microphone may be configured to, respectively, measure a first ambient noise and a second ambient noise. The first and second ambient noise cancelling modules may be configured to process the first and second ambient noises, such that a first and a second negative output audios are created, which may be configured to destructively interfere, relatively, with the first and second ambient noises. Similarly, the first and second active cancelling modules may be configured to process the first and second near field noises, such that a first and second negative output audios are created that may be configured to destructively interfere, relatively, with the first and second near field noises. Alternatively, the first and second active noise cancelling modules may be configured to process, respectively, both the first and second near field noises and the first and second ambient noises, such that a first and second negative output audios may be created that may be configured to destructively interfere, relatively, with both the first and second near field noises and the first and second ambient noises.

Regarding the cancellation of ambient audio: the first and second negative output audios may be configured to be respectively emitted from the first and second sets of one or more loudspeakers, such that the first and second ambient noises may be substantially cancelled or reduced. Regarding the cancellation of near field audio: the first and second negative output audios may be configured to be respectively emitted from the first and second sets of one or more loudspeakers, such that the first and second near field noises may be substantially cancelled or reduced. In some instances, the ambient and near field audio may both be substantially cancelled or reduced, wherein the first and second negative output audios may be configured to be respectively emitted from the first and second sets of one or more loudspeakers, such that both the first and second near field noises, and the first and second ambient noises may be substantially cancelled or reduced.

Preferably, the first and second noise cancelling speaker bulbs may be configured to receive an audio signal from one or more media sources and subsequently play the audio signal from the first and second sets of one or more loudspeakers; wherein the first noise cancelling speaker may comprise a first set of one or more adjustable bases and a first set of one or more actuators; wherein the second noise cancelling speaker bulb may comprise a second set of one or more adjustable bases and a second set of one or more actuators; wherein the first set of one or more loudspeakers may be mounted on the first set of one or more adjustable bases; wherein the first set of one or more actuators may be configured to adjust the first set of one or more adjustable bases; wherein the second set of one or more loudspeakers may be mounted on the second set of one or more adjustable bases; and wherein the second set of one or more actuators may be configured to adjust the second set of one or more adjustable bases.

One embodiment may be a noise cancelling speaker bulb system, comprising: a first noise cancelling speaker bulb; wherein the first noise cancelling speaker bulb comprises: at least one first loudspeaker; at least one first microphone, which may be configured to sense and measure a first ambient noise; and a first active noise cancelling module, which may be configured to be in communication with the at least one first loudspeaker and the at least one first microphone; wherein the first active noise cancelling module may process the first ambient noise to create a first negative output audio; wherein the first negative output audio may be configured to be projected from the at least one first loudspeaker; and wherein the first negative output audio, when projected from the at least one first loudspeaker, destructively interferes with the first ambient noise; a second noise cancelling speaker bulb; wherein the second noise cancelling speaker bulb comprises: at least one second loudspeaker; at least one second microphone, which may be configured to sense and measure a second ambient noise; and a second active noise cancelling module, which may be configured to be in communication with the at least one second loudspeaker and the at least one second microphone; wherein the second active noise cancelling module may process the second ambient noise to create a second negative output audio; wherein the second negative output audio may be configured to be projected from the at least one second loudspeaker; and wherein the second negative output audio, when projected from the at least one second loudspeaker, destructively interferes with the second ambient noise; wherein the first and second noise cancelling speaker bulb are configured to be in communication with each other, such that they work together to destructively interfere with the first and second ambient noises. In some embodiments, the first and second noise cancelling speaker bulbs may be physically connected to each other. In others, they may communicate or otherwise be connected by a wire connection or a wireless connection. The first and second noise cancelling speaker bulbs may be configured to be engaged to or in the structures selected from the group of structures consisting of one or more of: a mounted lamp like enclosure, a table lamp enclosure or a floor lamp enclosure. The first noise cancelling speaker bulb may further comprise: at least one first adjustable loudspeaker base and at least one first adjustable microphone base; wherein the at least one first loudspeaker may be mounted on the at least one first adjustable loudspeaker base; wherein the at least one first microphone may be mounted on the at least one first adjustable microphone base; wherein the at least one first adjustable loudspeaker base may be configured to be adjustable so as to adjust an angle of the at least one first loudspeaker, thereby adjusting the first negative output audio, such that the first negative output audio may be configured to destructively interfere with the first ambient noise; and wherein the at least one first adjustable microphone base may be configured to adjust an angle of the at least one first microphone to improve sensing and measuring of the first ambient noise. The second noise cancelling speaker bulb may further comprise: at least one second adjustable loudspeaker base; and at least one second adjustable microphone base; wherein the at least one second loudspeaker may be mounted on the at least one second adjustable loudspeaker base; wherein the at least one second microphone may be mounted on the at least one second adjustable microphone base; wherein the at least one second adjustable loudspeaker base may be configured to be adjustable so as to adjust an angle of the at least one second loudspeaker, thereby adjusting the second negative output audio, such that the second negative output audio may be configured to destructively interfere with the second ambient noise; and wherein the at least one second adjustable microphone base may be configured to adjust an angle of the at least one second microphone to improve sensing and measuring of the second ambient noise. The first ambient noise experienced by a user is substantially reduced when the first ambient noise is destructively interfered with by the first negative audio output; and wherein the second ambient noise experienced by a second user is substantially reduced when the second ambient noise is destructively interfered with by the second negative audio output. The first and second noise cancelling speaker bulb may be configured to receive an audio signal from one or more media sources and subsequently play the audio signal from the first and second loudspeakers. The first and second ambient noises may be substantially the same. The first and second noise cancelling speaker bulb may be configured to be controlled by a control interface, such as a remote control device. The noise cancelling speaker bulb system may further comprise at least one external microphone, which may be configured to sense and measure an external ambient noise; wherein the at least one external microphone may be configured to be in communication with first active noise cancelling module; wherein the first active noise cancelling module may process the external ambient noise to create an external negative output audio; wherein the external negative output audio may be configured to be projected from the at least one first loudspeaker; and wherein the external negative output audio, when projected from the at least one first loudspeaker, destructively interferes with the external ambient noise. The at least one first noise cancelling speaker bulb may be configured to be in communication with at least one external microphone, which may be configured to sense and measure an external ambient noise; wherein the at least one external microphone may be configured to be in communication with first active noise cancelling module; wherein the first active noise cancelling module may process the external ambient noise to create an external negative output audio; wherein the external negative output audio may be configured to be projected from the at least one first loudspeaker; and wherein the external negative output audio, when projected from the at least one first loudspeaker, destructively interferes with the external ambient noise.

Another embodiment may be a noise cancelling speaker bulb system, comprising: a first noise cancelling speaker bulb; wherein the first noise cancelling speaker bulb comprises: at least one first loudspeaker; at least one first microphone, which may be configured to sense and measure a first ambient noise; and a first active noise cancelling module, which may be configured to be in communication with the at least one first loudspeaker and the at least one first microphone; wherein the first active noise cancelling module processes the first ambient noise to create a first negative output audio; wherein the first negative output audio may be configured to be projected from the at least one first loudspeaker; and wherein the first negative output audio, when projected from the at least one first loudspeaker, destructively interferes with the first ambient noise; a noise cancelling speaker bulb slave device; wherein the noise cancelling speaker bulb slave device comprises: at least one slave loudspeaker, which may be configured to be in communication with the first active noise cancelling module; and at least one slave microphone, which may be configured to be in communication with the first active noise cancelling module, and which may be configured to sense and measure a slave ambient noise; wherein the first active noise cancelling module processes the slave ambient noise to create a slave negative output audio; wherein the second negative output audio may be configured to be projected from the at least one slave loudspeaker; and wherein the slave negative output audio, when projected from the at least one slave loudspeaker, destructively interferes with the slave ambient noise; and wherein the noise cancelling speaker bulb slave device may be configured to be in communication with the first noise cancelling speaker bulb, such that they work together to destructively interfere with the first and slave ambient noises. The first noise cancelling speaker bulb may be physically connected to the noise cancelling speaker bulb slave device or it may be separate and connected via wire or wirelessly. The first noise cancelling speaker bulb and the noise cancelling speaker bulb slave device may be configured to be engaged to or in the structures selected from the group of structures consisting of one or more of: a wall; a headboard; and combinations thereof. The first noise cancelling speaker bulb may further comprise: at least one first adjustable loudspeaker base; and at least one first adjustable microphone base; wherein the at least one first loudspeaker may be mounted on the at least one first adjustable loudspeaker base; wherein the at least one first microphone may be mounted on the at least one first adjustable microphone base; wherein the at least one first adjustable loudspeaker base may be configured to be adjustable so as to adjust an angle of the at least one first loudspeaker, thereby adjusting the first negative output audio, such that the first negative output audio is configured to destructively interfere with the first ambient noise; and wherein the at least one first adjustable microphone base may be configured to adjust an angle of the at least one first microphone to improve sensing and measuring of the first ambient noise. The noise cancelling speaker bulb slave device may further comprise: at least one slave adjustable loudspeaker base; and at least one slave adjustable microphone base; wherein the at least one slave loudspeaker may be mounted on the at least one slave adjustable loudspeaker base; wherein the at least one slave microphone may be mounted on the at least one slave adjustable microphone base; wherein the at least one slave adjustable loudspeaker base may be configured to be adjustable so as to adjust an angle of the at least one slave loudspeaker, thereby adjusting the slave negative output audio, such that the slave negative output audio is configured to destructively interfere with the slave ambient noise; and wherein the at least one slave adjustable microphone base may be configured to adjust an angle of the at least one slave microphone to improve sensing and measuring of the slave ambient noise. The first ambient noise experienced by a user is substantially reduced when the first ambient noise is destructively interfered with by the first negative audio output; and wherein the slave ambient noise experienced by a second user is substantially reduced when the slave ambient noise is destructively interfered with by the slave negative audio output. The first noise cancelling speaker bulb may be configured to receive an audio signal from one or more media sources and subsequently play the audio signal from the at least one first loudspeaker and the at least one slave loudspeaker. Sometimes, the first and slave ambient noises may be substantially the same. The first noise cancelling speaker bulb and the noise canceling speaker bulb slave device may be configured to be controlled by a control interface. The noise cancelling speaker bulb system may further comprise at least one external microphone, which may be configured to sense and measure an external ambient noise; wherein the at least one external microphone may be configured to be in communication with first active noise cancelling module; wherein the first active noise cancelling module processes the external ambient noise to create an external negative output audio; wherein the external negative output audio may be configured to be projected from the at least one first loudspeaker; and wherein the external negative output audio, when projected from the at least one first loudspeaker, destructively interferes with the external ambient noise. Rather than being part of the system, the remote/external microphone can be an external system that is connected to the present system. Specifically, the at least one first noise controlling speaker bulb may be configured to be in communication with at least one external microphone, which may be configured to sense and measure an external ambient noise; wherein the at least one external microphone may be configured to be in communication with first active noise cancelling module; wherein the first active noise cancelling module processes the external ambient noise to create an external negative output audio; wherein the external negative output audio may be configured to be projected from the at least one first loudspeaker; and wherein the external negative output audio, when projected from the at least one first loudspeaker, destructively interferes with the external ambient noise.

Another embodiment may be a noise cancelling speaker bulb system, comprising: a noise cancelling speaker bulb; wherein the noise cancelling speaker bulb comprises: at least one first loudspeaker; at least one first microphone, which may be configured to sense and measure a first ambient noise; a first active noise cancelling module, which may be configured to be in communication with the at least one first loudspeaker and the at least one first microphone; at least one first adjustable loudspeaker base; and at least one first adjustable microphone base; wherein the first active noise cancelling module processes the first ambient noise to create a first negative output audio, and a battery to provide power to the system which may or may not be rechargeable; wherein the first negative output audio may be configured to be projected from the at least one first loudspeaker; and wherein the first negative output audio, when projected from the at least one first loudspeaker, destructively interferes with the first ambient noise; wherein the first noise cancelling speaker bulb may be configured to be engaged to or in the structures selected from the group of structures consisting of one or more of a speaker enclosure mounted to a structure, speaker enclosure mounted on a base that sits on a table, mounted on a base that sits on the floor. ; wherein the at least one first loudspeaker may be mounted on the at least one first adjustable loudspeaker base; wherein the at least one first microphone may be mounted on the at least one first adjustable microphone base; wherein the at least one first adjustable loudspeaker base may be configured to be adjustable so as to adjust an angle of the at least one first loudspeaker, thereby adjusting the first negative output audio, such that the first negative output audio is configured to destructively interfere with the first ambient noise; and wherein the at least one first adjustable microphone base may be configured to adjust an angle of the at least one first microphone to improve sensing and measuring of the first ambient noise. The first ambient noise experienced by a user is substantially reduced when the first ambient noise is destructively interfered with by the first negative audio output. The first noise cancelling speaker bulb may be configured to receive an audio signal from one or more media sources and subsequently play the audio signal from the first loudspeaker. The first noise cancelling speaker bulb may be configured to be controlled by a control interface. The noise cancelling speaker bulb system may further comprise at least one external microphone, which may be configured to sense and measure an external ambient noise; wherein the at least one external microphone may be configured to be in communication with first active noise cancelling module; wherein the first active noise cancelling module processes the external ambient noise to create an external negative output audio; wherein the external negative output audio may be configured to be projected from the at least one first loudspeaker; and wherein the external negative output audio, when projected from the at least one first loudspeaker, destructively interferes with the external ambient noise. Alternatively, the at least one first noise cancelling speaker bulb may be configured to be in communication with at least one external microphone, which may be configured to sense and measure an external ambient noise; wherein the at least one external microphone may be configured to be in communication with first active noise cancelling module; wherein the first active noise cancelling module processes the external ambient noise to create an external negative output audio; wherein the external negative output audio may be configured to be projected from the at least one first loudspeaker; and wherein the external negative output audio, when projected from the at least one first loudspeaker, destructively interferes with the external ambient noise.

By extending the above methodology to multiple noise cancelling speaker bulbs (e.g., three or more), it will be apparent to those of skill in the art that the devices, systems, and methods of the present disclosure may be modified to include larger numbers of speakers used in tandem, to create an interconnected network of semi-soundproof listening zones, one for each noise cancelling speaker bulbs in the network.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps, which are illustrated. When the same numeral appears in different drawings, it refers to the same or like components or steps.

FIG. 1A is an illustration in which a noise cancelling speaker bulb featuring an Edison E27 screw without any lighting element.

FIG. 1B is an illustration in which a noise cancelling speaker bulb featuring an Edison E27 screw with a lighting element.

FIG. 2A is an illustration in which a noise cancelling speaker bulb featuring an Edison E14 screw without any lighting element.

FIG. 2B is an illustration in which a noise cancelling speaker bulb featuring an Edison E14 screw with a lighting element.

FIG. 3A is an illustration in which a noise cancelling speaker bulb featuring a GU10 male connector without any lighting element.

FIG. 3B is an illustration in which a noise cancelling speaker bulb featuring GU10 male connector with a lighting element.

FIG. 4A is an illustration in which a noise cancelling speaker bulb featuring a track light mount without any lighting element.

FIG. 4B is an illustration in which a noise cancelling speaker bulb featuring a track light mount with a lighting element.

FIG. 5A is an illustration in which a noise cancelling speaker bulb featuring an Edison E27 screw and swivel head (that permits aiming of the device) without any lighting element.

FIG. 5B is an illustration in which a noise cancelling speaker bulb featuring an Edison E27 screw and swivel head (that permits aiming of the device) with a lighting element.

FIG. 6A is an illustration in which a noise cancelling speaker bulb featuring an Edison E14 screw and swivel head (that permits aiming of the device) without any lighting element.

FIG. 6B is an illustration in which a noise cancelling speaker bulb featuring an Edison E14 screw and swivel head (that permits aiming of the device) with a lighting element.

FIG. 7A is an illustration in which a noise cancelling speaker bulb featuring a GU10 male connector and swivel head (that permits aiming of the device) without any lighting element.

FIG. 7B is an illustration in which a noise cancelling speaker bulb featuring GU10 male connector and swivel head (that permits aiming of the device) with a lighting element.

FIG. 8A is an illustration in which a noise cancelling speaker bulb featuring a track light mount and swivel head (that permits aiming of the device) without any lighting element.

FIG. 8B is an illustration in which a noise cancelling speaker bulb featuring a track light mount and swivel head (that permits aiming of the device) with a lighting element.

FIG. 9 is also an illustration of the prior art, detailing the technology that can be built into a noise cancelling speaker or be housed in elsewhere. For example, microphones used for measuring sound may be placed in positions closer to the noise source. Speakers and lighting fixtures may be run by wire to the electronics package that is centrally located with the music system (for example).

### DETAILED DESCRIPTION OF THE ILLUSTRATIVE EMBODIMENTS

In the following detailed description of various embodiments, numerous specific details are set forth in order to provide a thorough understanding of various aspects of the embodiments. However, these embodiments may be practiced without some or all of these specific details. In other instances, well-known methods, procedures, and/or components have not been described in detail so as not to unnecessarily obscure aspects of the embodiments.

While multiple embodiments are disclosed, still others will become apparent to those skilled in the art from the following detailed description. As will be realized, these embodiments are capable of modifications in various obvious aspects, all without departing from the spirit and scope of protection. Accordingly, the graphs, figures, and the detailed descriptions thereof, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about,” may refer to a deviance of between 0.0001-10% from the indicated number or range of numbers.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signified both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “noise cancelling speaker” generally refers to a speaker or array of sound equipment that may be equipped with active noise cancelling technology.

“Ambient sound(s)” and “ambient sound waves” refer generally to sounds waves present in the vicinity of a noise cancelling speaker of the present disclosure. This includes, but is not limited to, electronically generated audio (such as that produced by a loudspeaker in response to an electrical signal) and naturally generated audio (such as that produced by people talking, traffic and construction noises, etc.).

“Disruptive Audio” refers to any ambient sound waves that a user of a noise cancelling sound speaker of the present disclosure is not actively trying to listen to, or is trying to avoid listening to.

The terms “negative sound wave(s)” and “negative sound output pattern” refer to machine-generated soundwaves that are calculated to destructively interfere with a counterpart disruptive audio.

“Media” refers to any form of audio and/or audiovisual content that includes an audio component for listeners to hear.

“View” refers to the act of engaging with audio and/or audiovisual media, regardless of whether the viewer is looking and listening, or only listening.

The term “set” generally refers to a group of things, such as loudspeakers, but there may be only one thing in any specific group.

Embodiments of the present disclosure generally relate to the field of speakers. More specifically, the present disclosure relates to a noise cancelling speaker which, through a combination of a small form factor, targeted audio output, and active noise cancelling, allows its users to listen to audio or audiovisual media without disturbing nearby users.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments. It is to be understood that the methods and systems are not limited to specific methods, specific components, or to particular implementations. It is also to be understood that the terminology used herein is for the purpose of describing particular embodiments only and is not intended to be limiting.

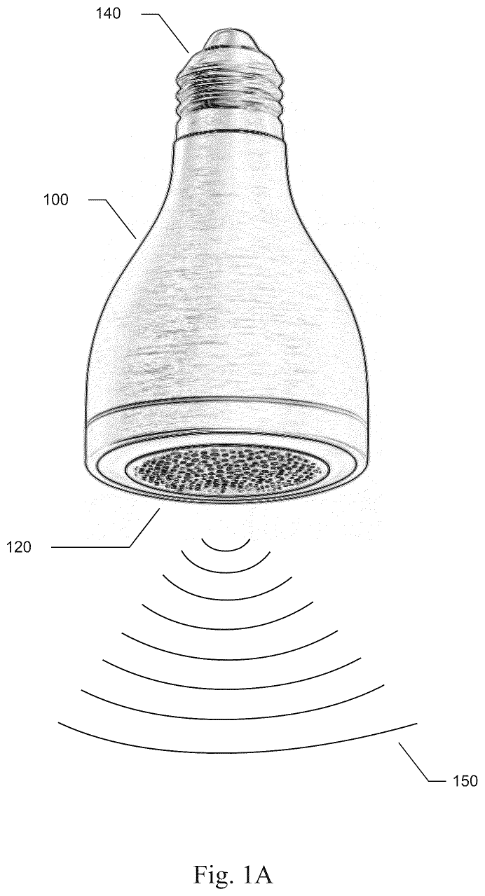

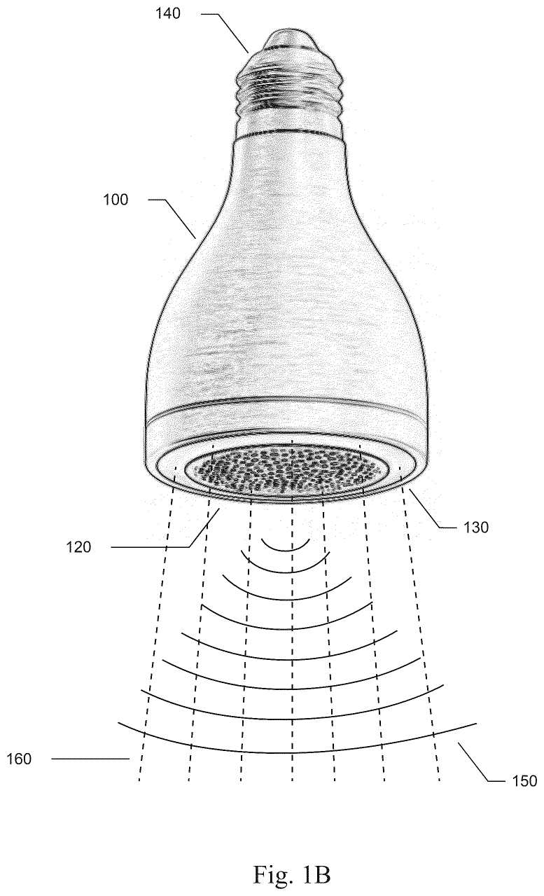

FIG. 1A is an illustration showing a common noise cancelling speaker bulb setup. As shown in FIG. 1A, a speaker 120 is mounted to a structure 100 such as fixture that has an Edison E27 bulb thread 140. It is producing sound 150.

FIG. 1B is an illustration showing a common noise cancelling speaker bulb setup. As shown in FIG. 1B, a speaker 120 is mounted to a structure 100 such as fixture that has an Edison E27 bulb thread 140. It is producing sound 150. A lighting element 130 produces light 160.

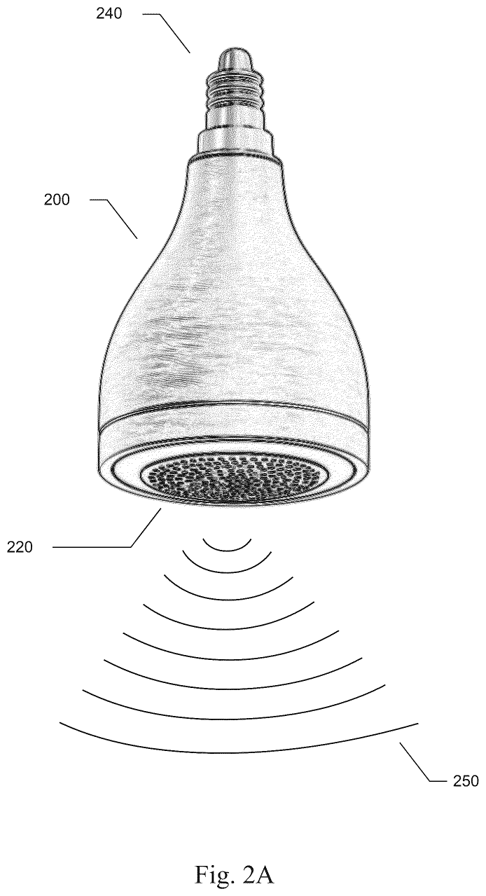

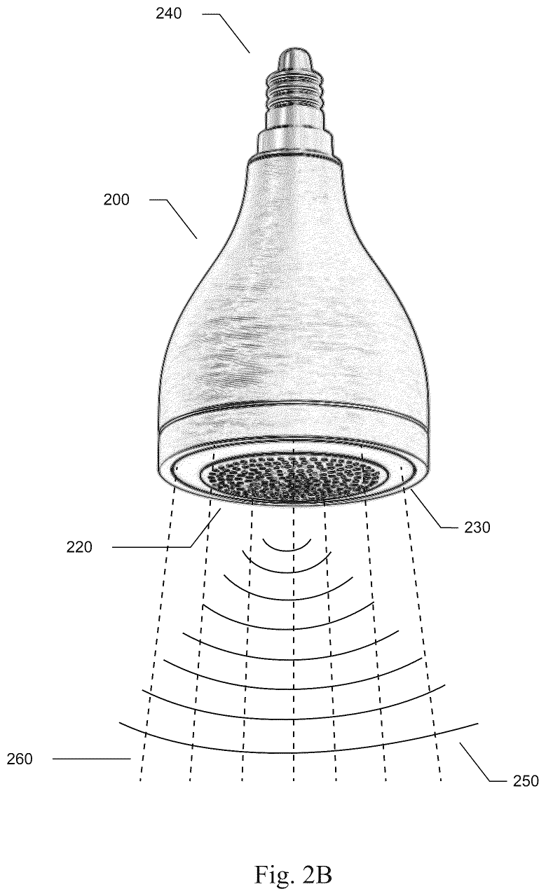

FIG. 2A is an illustration showing a common noise cancelling speaker bulb setup. As shown in FIG. 2A, a speaker 220 is mounted to a structure 200 such as fixture that has an Edison E14 bulb thread 240. It is producing sound 250.

FIG. 2B is an illustration showing a common noise cancelling speaker bulb setup. As shown in FIG. 2B, a speaker 220 is mounted to a structure 200 such as fixture that has an Edison E27 bulb thread 240. It is producing sound 250. A lighting element 230 produces light 260.

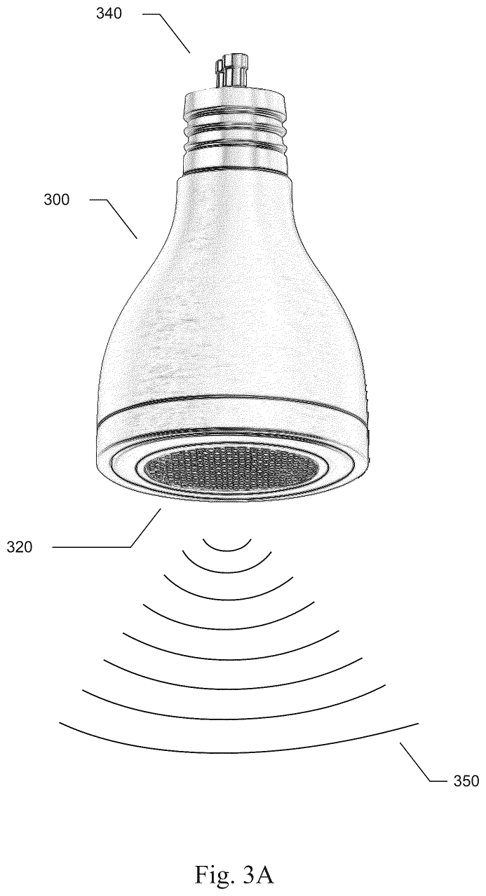

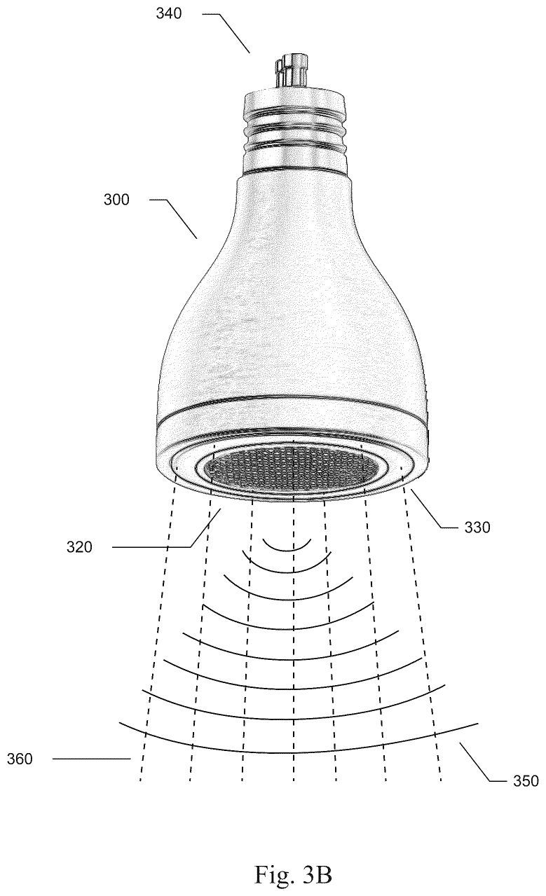

FIG. 3A is an illustration showing a common noise cancelling speaker bulb setup. As shown in FIG. 3A, a speaker 320 is mounted to a structure 300 such as fixture that has a GU10 male connector 340. It is producing sound 350.

FIG. 3B is an illustration showing a common noise cancelling speaker bulb setup. As shown in FIG. 3B, a speaker 320 is mounted to a structure 300 such as fixture that has a GU10 male connector 340. It is producing sound 350. A lighting element 330 produces light 360.

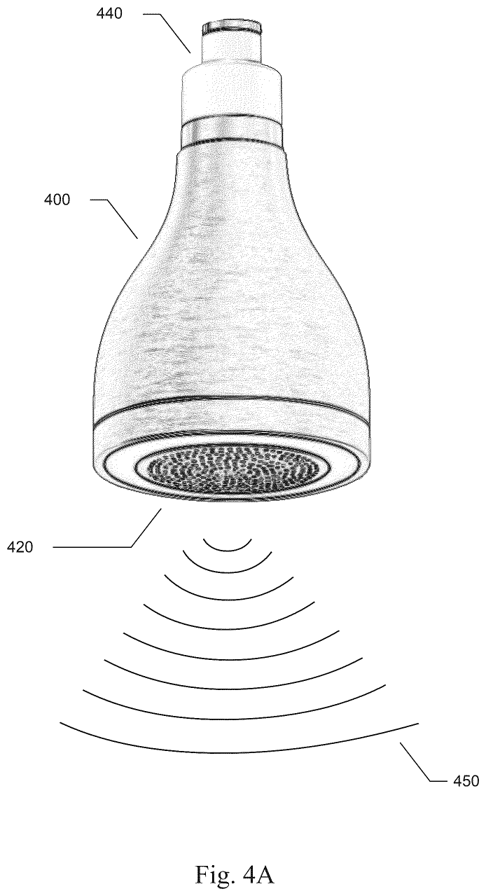

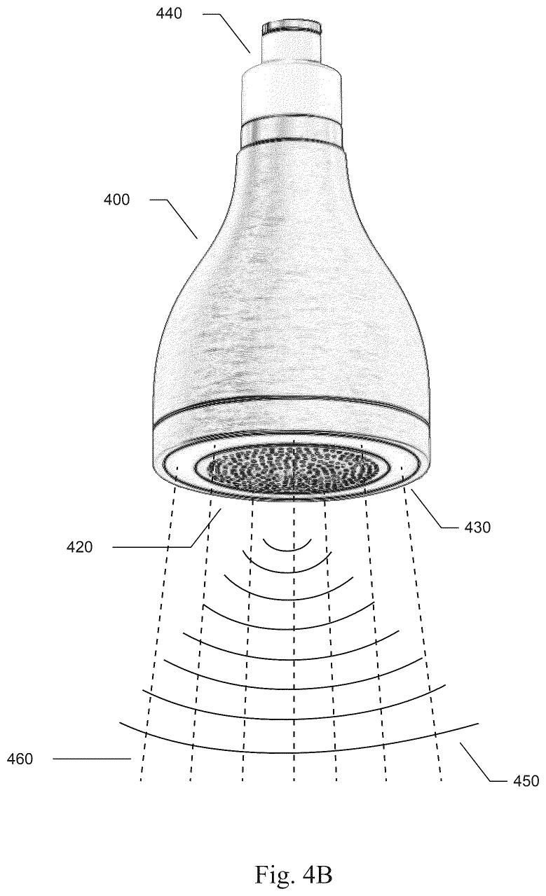

FIG. 4A is an illustration showing a common noise cancelling speaker bulb setup. As shown in FIG. 4A, a speaker 420 is mounted to a structure 400 such as fixture that has a track light mount 440. It is producing sound 450.

FIG. 4B is an illustration showing a common noise cancelling speaker bulb setup. As shown in FIG. 4B, a speaker 420 is mounted to a structure 400 such as fixture that has a track light mount 440. It is producing sound 450. A lighting element 430 produces light 460.

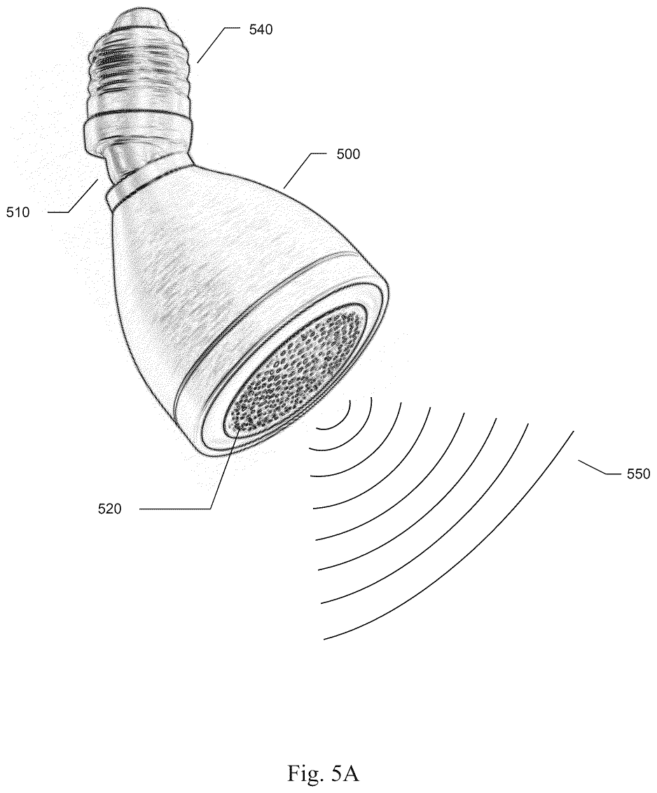

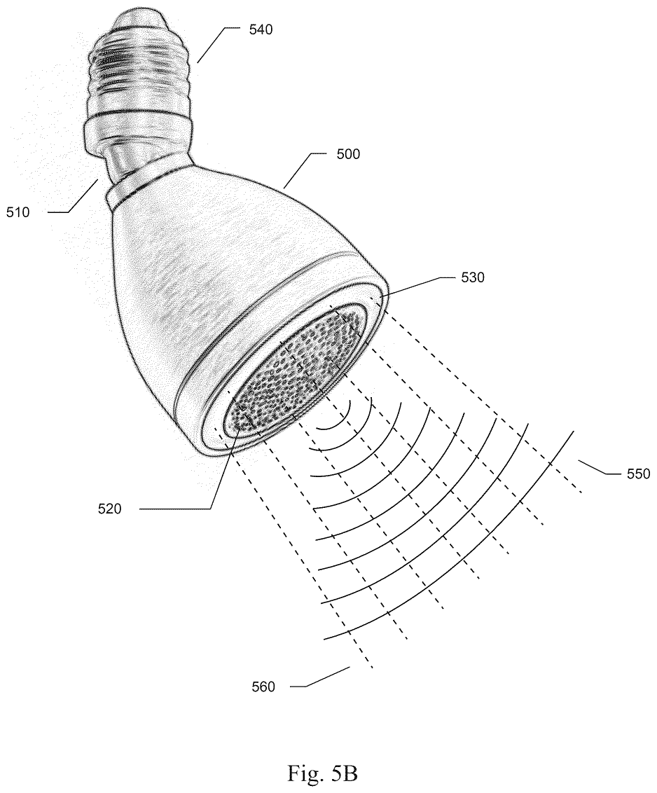

FIG. 5A is an illustration showing a common noise cancelling speaker bulb setup. As shown in FIG. 5A, a speaker 520 is mounted to a structure 500 such as fixture that has an Edison E27 bulb thread 540 and swivel head (that permits aiming of the device) 510. It is producing sound 550.

FIG. 5B is an illustration showing a common noise cancelling speaker bulb setup. As shown in FIG. 1B, a speaker 520 is mounted to a structure 500 such as fixture that has an Edison E27 bulb thread 540 and swivel head (that permits aiming of the device) 510. It is producing sound 550. A lighting element 530 produces light 560.

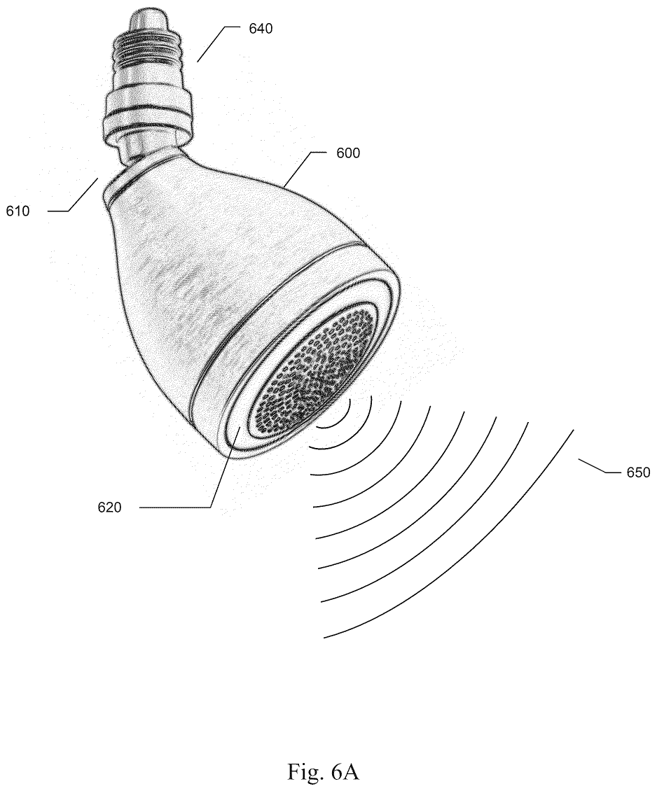

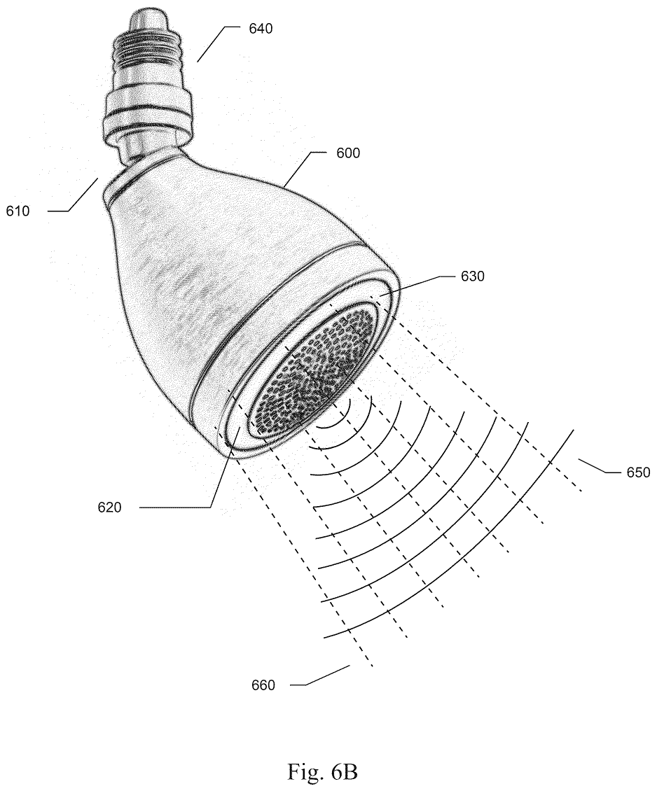

FIG. 6A is an illustration showing a common noise cancelling speaker bulb setup. As shown in FIG. 6A, a speaker 620 is mounted to a structure 600 such as fixture that has an Edison E14 bulb thread 640 and swivel head (that permits aiming of the device) 610. It is producing sound 650.

FIG. 6B is an illustration showing a common noise cancelling speaker bulb setup. As shown in FIG. 6B, a speaker 620 is mounted to a structure 600 such as fixture that has an Edison E27 bulb thread 640 and swivel head (that permits aiming of the device) 610. It is producing sound 650. A lighting element 630 produces light 660.

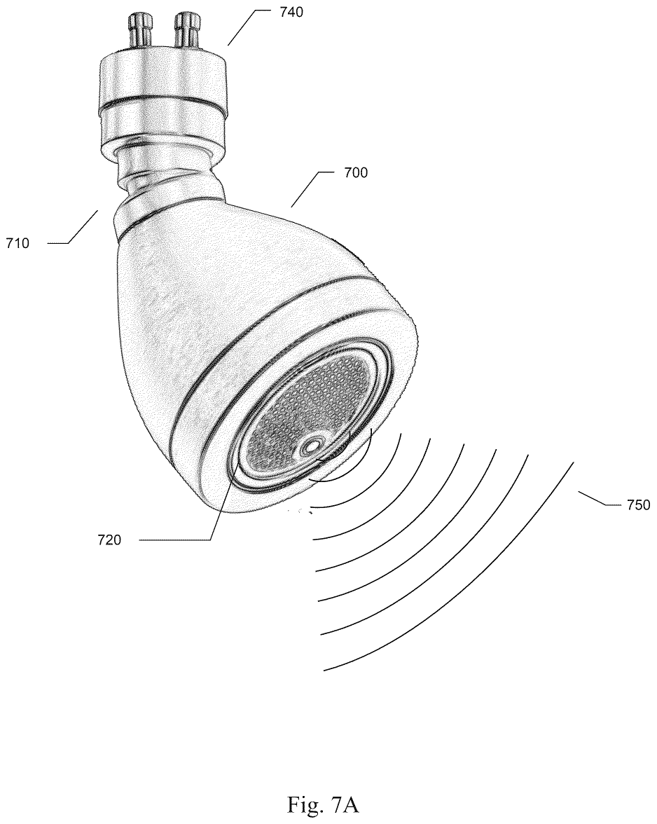

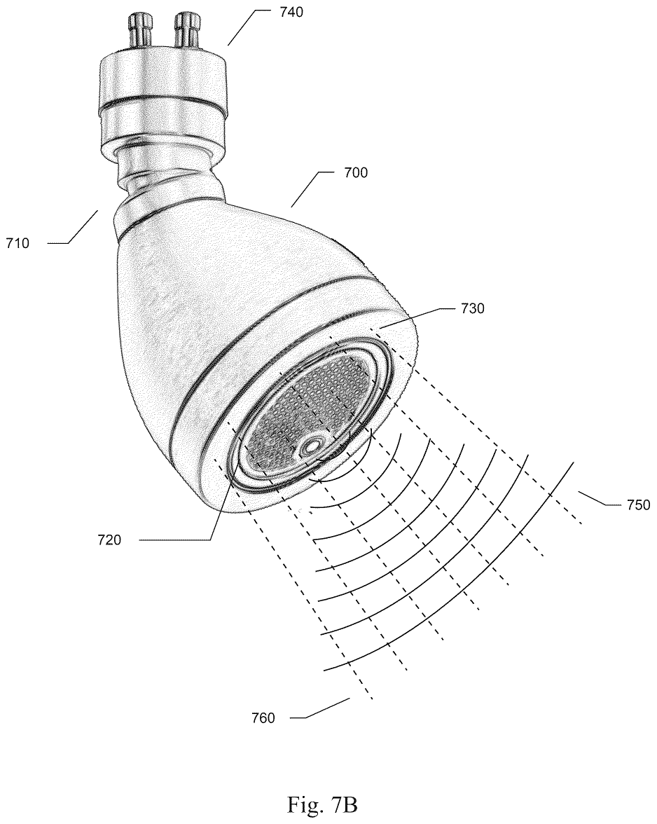

FIG. 7A is an illustration showing a common noise cancelling speaker bulb setup. As shown in FIG. 7A, a speaker 720 is mounted to a structure 700 such as fixture that has a GU10 male connector 740 and swivel head (that permits aiming of the device) 710. It is producing sound 750.

FIG. 7B is an illustration showing a common noise cancelling speaker bulb setup. As shown in FIG. 7B, a speaker 720 is mounted to a structure 700 such as fixture that has a GU10 male connector 740 and swivel head (that permits aiming of the device) 710. It is producing sound 750. A lighting element 730 produces light 760.

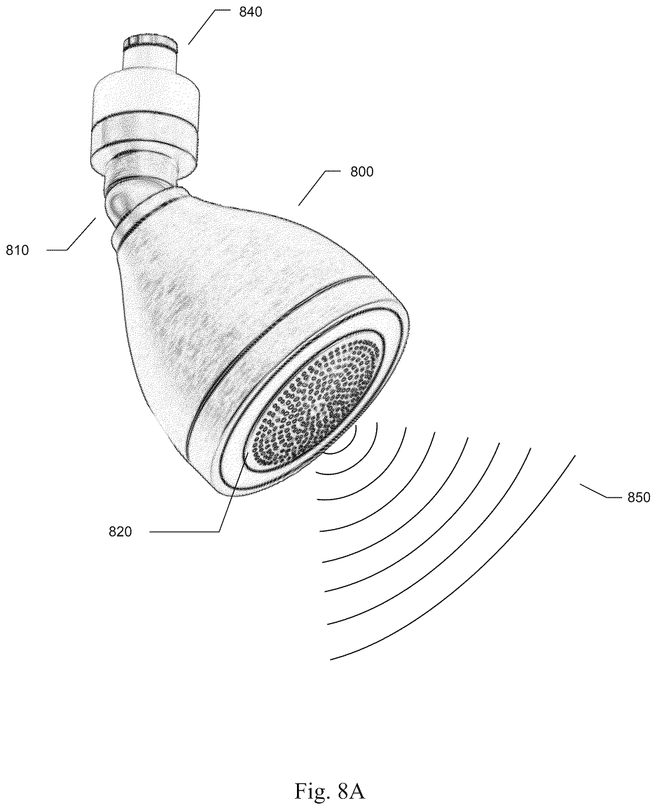

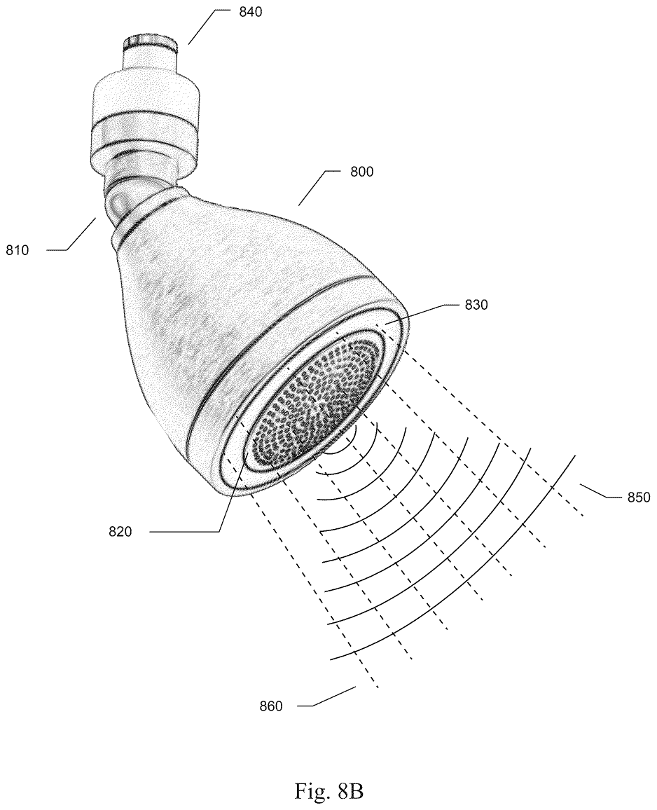

FIG. 8A is an illustration showing a common noise cancelling speaker bulb setup. As shown in FIG. 8A, a speaker 820 is mounted to a structure 800 such as fixture that has a track light mount 840 and swivel head (that permits aiming of the device) 810. It is producing sound 850.

FIG. 8B is an illustration showing a common noise cancelling speaker bulb setup. As shown in FIG. 8B, a speaker 820 is mounted to a structure 800 such as fixture that has a track light mount 840 and swivel head (that permits aiming of the device) 810. It is producing sound 850. A lighting element 830 produces light 860.

is an illustration showing a common speaker setup. As shown in FIG. 2, a speaker 250 is mounted to a structure 200 such as a wall, ceiling, truss or beam. It is producing sound 280. It may be hung on a support 240 which could be a rod, pole, cable or wire or mounted into the surface of a ceiling. By adding a mount 230, the speaker's position can be adjusted.

FIG. 3 is an illustration showing a common speaker setup. As shown in FIG. 3, a speaker 350 is mounted to a structure 300 such as a ceiling, truss or beam. It is producing sound 380 and light 390. It may be hung on a support 340 which could be a rod, pole, cable or wire or mounted into the surface of a ceiling. By adding a mount 330, the speaker's position can be adjusted.

FIG. 4 is an illustration showing a common speaker setup. As shown in FIG. 4, a speaker 450 is mounted to a structure 400 such as a ceiling, truss or beam. It is producing sound 480 and light 490. It may be hung on a support 440 which could be a rod, pole, cable or wire or mounted into the surface of a ceiling. By adding a mount 430, the speaker's position can be adjusted.

FIG. 5 is an illustration showing a common floor standing speaker setup. As shown in FIG. 5, a speaker 550 is mounted to stand 535 that is mounted to or sits on a surface such as the floor 520. It is producing sound 580 and if the option is included, light 590.

FIG. 6 is an illustration showing a common table standing speaker setup. As shown in FIG. 6, a speaker 650 is mounted to stand 635 that or sits on a surface such as a table or bar 610. It is producing sound 680 and if the option is included, light 690. The speaker can fire downward or if the speaker 650 has a short stand 635, it can also fire the sound upwards while providing light downward. The holes 655 indicate a porous surface on the speaker 650 to permit sound to emanate from the speaker 650.

FIG. 7 is an illustration showing a common table standing speaker setup. As shown in FIG. 7, a speaker 750 is mounted to stand 735 that or sits on a surface such as a table or bar 710. It is producing sound 780 and if the option is included, light 790. The speaker can fire downward or if the speaker 750 has a short stand 735, it can also fire the sound upwards while providing light downward. The holes 755 indicate a porous surface on the speaker 750 to permit sound to emanate from the speaker 750. In this version of the speaker is self-powered using an internal battery that can be either a disposable or a rechargeable battery. For rechargeable batteries, the internal battery can be recharged when connected to power 760 or via induction or contact charging using a charging base 770 which is connected to power 760.

FIG. 8 is an illustration showing a radial speaker that generates sounds in all directions or if desired specific angles. As shown in FIG. 8, a speaker 850 is mounted to stand 835 that or sits on a surface such as the floor 820, a table 810 or is suspended from a ceiling or structure 800. It is producing sound 880 and if the option is included, light 890.

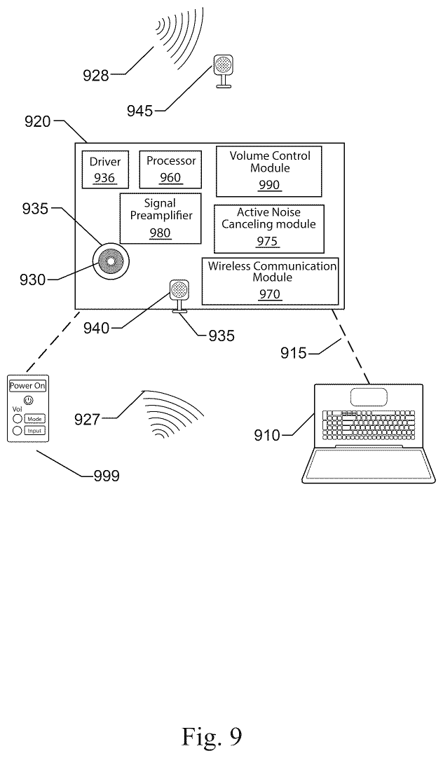

FIG. 9 is an illustration of the prior art. As shown in FIG. 9, the noise cancelling speaker bulb system may comprise a noise cancelling speaker bulb 920. FIG. 9 shows that the noise cancelling speaker bulb 920 where one or more loudspeakers 930, and one or more microphones 940. Preferably, the noise cancelling speaker bulb 920 may comprise a processor 960, a wireless communication module 970, and a signal preamplifier 980 that operates the noise cancelling speaker bulb 920. The noise cancelling speaker bulb 920 may receive an audio input signal 915 from a media device 910, such as a television (TV), smartphone, tablet, or other device capable of playing audio and/or audiovisual media. The audio input signal 915 may be transmitted to the noise cancelling speaker bulb 920 wirelessly and be received by the wireless communication module 970. The audio input signal 915 may, alternatively, be transmitted to the noise cancelling speaker bulb 920 via a wired connection.

The audio input signal 915 may be enhanced by the signal preamplifier 980, and then subsequently transmitted to the one or more loudspeakers 930 for the user to hear. The one or more loudspeakers 930 may use the (amplified) audio input signal 915 to create a speaker output audio 937. The speaker output audio 937 may be a faithful reproduction of the audio input signal 915 received from the media device 910, albeit enhanced and/or amplified. In situations in which the media device 910 includes loudspeakers of its own, the media device 910 loudspeakers may preferably be powered down while the noise cancelling speaker bulb 920 are in use, such that only the noise cancelling speaker bulb 920 are generating audible sounds pertaining to the media that the user is viewing and listening. The volume of the speaker output audio 937 may be controlled by a volume control module 990, which may allow communication with, for example, a control interface 999.

The one or more loudspeakers 930 may be mounted on a rotatable (or otherwise moveable/adjustable) bases 935 which may be controlled by driver 936. The rotatable base 935 may be underneath the one or more loudspeakers 930 and may be used to adjust the angle of the one or more loudspeakers 930, thereby adjusting the directional output of the speaker output audio 937. In this manner, the one or more loudspeakers 930 may be adjusted such that the speaker output audio 937 may be precisely aimed (or otherwise directed) at a user's ears. As a result, a lower volume is required for the speaker output audio 937 to be clearly heard by the user.

The noise cancelling speaker bulb 920 may further comprise one or more microphones 940 which may be used to measure or otherwise determine an ambient noise 927. The ambient noise 927 may be processed by an active noise cancelling module 975, to create a negative output audio that may destructively interfere with the ambient noise 927 when combined with the ambient noise 927. Preferably, the negative output audio may be emitted from the one or more loudspeakers 930, such that the negative output audio largely cancels out any disruption by the ambient noise 927 to a user of the noise cancelling speaker bulb 920. The one or more microphones 940 may be mounted on rotatable (or otherwise moveable/adjustable) bases 935, which may be used to adjust the angle of the one or more microphones 940 in order to improve the measurement of ambient noise 927. The bases 934 may be controlled manually or by driver 936.

The noise cancelling speaker bulb system may be in communication with one or more external (or remote) microphones 945, that are positioned apart from the noise cancelling speaker bulb 920. The external microphone(s) 945 may connect to the noise cancelling speaker 920 via a wired or wireless interface. The external microphone(s) 945 may be used to measure ambient noise 928 (external ambient noise) not directly near (greater than 2 meters away) the noise cancelling speaker system. The ambient noise 928 may be processed by an active noise cancelling module 975, to create a negative output audio which may destructively interfere with the ambient noise 928 when combined with the ambient noise 928. Preferably, the negative output audio may be emitted from the one or more loudspeakers 930, such that the negative output audio largely cancels out any disruption by the ambient noise 928 to a user of the noise cancelling speaker system 900. Preferably, the one or more external microphones 945 may be moveable and repositionable to areas in a room or outside of a room to most advantageously create a negative output audio for destructively cancelling the ambient noise 928. The external microphones 945 may be connected to moveable and rotatable bases similar to bases 935.

The noise cancelling speaker bulb system may be connected to one or more control interface 999, such as a remote control unit, which may be a separate unit or may be mounted into or onto the noise cancelling speaker bulb 920 into room furnishings (i.e. base, table, etc.), into or onto a wall, or be used as a separate handheld device. The control interface 999 may connect to the noise cancelling speaker bulb system via wired or wireless connectivity. The control interface 999 can also be operated and/or adjusted by the media device 910 (i.e., computers, smart phones, control systems). In other embodiments, the control interface 999 is a computer, smart phone, or other control system.

Unless otherwise stated, all measurements, values, ratings, positions, magnitudes, sizes, locations, and other specifications, which set forth in this specification, including in the claims that follow, are approximate, not exact. They are intended to have a reasonable range, which is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A noise cancelling system, comprising:
a first noise cancelling speaker;
wherein said first noise cancelling speaker comprises: at least one first loudspeaker; at least one first microphone, which is configured to sense and measure a first ambient noise; and a first active noise cancelling module, which is configured to be in communication with said at least one first loudspeaker and said at least one first microphone;
wherein said first active noise cancelling module processes said first ambient noise to create a first negative output audio;
wherein said first negative output audio is configured to be projected from said at least one first loudspeaker; and
wherein said first negative output audio, when projected from said at least one first loudspeaker, destructively interferes with said first ambient noise.

2. The noise cancelling system of claim 1, wherein said first and second noise cancelling speakers are physically separate units and are in wired communication with each other.

3. The noise cancelling system of claim 1, wherein said first and second noise cancelling speaker are physically separate units and are in wireless communication with each other.

4. The noise cancelling system of claim 1, wherein said first and second noise cancelling speakers are configured to be engaged to or in one or more structures selected from the group of structures consisting of one or more of: a wall; a headboard; and combinations thereof as well as standing on a base regardless of length.

5. The noise cancelling system of claim 1:
wherein said first noise cancelling speaker further comprises:
at least one first adjustable loudspeaker base; and
at least one first adjustable microphone base;
wherein said at least one first loudspeaker is mounted on said at least one first adjustable loudspeaker base;
wherein said at least one first microphone is mounted on said at least one first adjustable microphone base;
wherein said at least one first adjustable loudspeaker base is configured to be adjustable so as to adjust an angle of said at least one first loudspeaker, thereby adjusting said first negative output audio, such that said first negative output audio is configured to destructively interfere with said first ambient noise; and
wherein said at least one first adjustable microphone base is configured to adjust an angle of said at least one first microphone to improve sensing and measuring of said first ambient noise;
wherein said second noise cancelling speaker further comprises:
at least one second adjustable loudspeaker base; and
at least one second adjustable microphone base;
wherein said at least one second loudspeaker is mounted on said at least one second adjustable loudspeaker base;
wherein said at least one second microphone is mounted on said at least one second adjustable microphone base;
wherein said at least one second adjustable loudspeaker base is configured to be adjustable so as to adjust an angle of said at least one second loudspeaker, thereby adjusting said second negative output audio, such that said second negative output audio is configured to destructively interfere with said second ambient noise; and
wherein said at least one second adjustable microphone base is configured to adjust an angle of said at least one second microphone to improve sensing and measuring of said second ambient noise.

6. The noise cancelling system of claim 1, wherein said first ambient noise experienced by a user is substantially reduced when said first ambient noise is destructively interfered with by said first negative audio output; and
wherein said second ambient noise experienced by a second user is substantially reduced when said second ambient noise is destructively interfered with by said second negative audio output.

7. The noise cancelling system of claim 1, wherein said first and second noise cancelling speakers are configured to receive an audio signal from one or more media sources and subsequently play the audio signal from said first and second loudspeakers.

8. The noise cancelling system of claim 1, further comprising at least one external microphone, which is configured to sense and measure an external ambient noise;
wherein said at least one external microphone is configured to be in communication with first active noise cancelling module;
wherein said first active noise cancelling module processes said external ambient noise to create an external negative output audio;
wherein said external negative output audio is configured to be projected from said at least one first loudspeaker; and
wherein said external negative output audio, when projected from said at least one first loudspeaker, destructively interferes with said external ambient noise.

9. The noise cancelling system of claim 1, wherein said first noise cancelling speaker is configured to be in communication with at least one external microphone, which is configured to sense and measure an external ambient noise;
wherein said at least one external microphone is configured to be in communication with first active noise cancelling module;
wherein said first active noise cancelling module processes said external ambient noise to create an external negative output audio;
wherein said external negative output audio is configured to be projected from said at least one first loudspeaker; and
wherein said external negative output audio, when projected from said at least one first loudspeaker, destructively interferes with said external ambient noise.

10. A noise cancelling system, comprising:
a first noise cancelling speaker;
wherein said first noise cancelling speaker comprises: at least one first loudspeaker; at least one first microphone, which is configured to sense and measure a first ambient noise; and a first active noise cancelling module, which is configured to be in communication with said at least one first loudspeaker and said at least one first microphone;
wherein said first active noise cancelling module processes said first ambient noise to create a first negative output audio;
wherein said first negative output audio is configured to be projected from said at least one first loudspeaker; and
wherein said first negative output audio, when projected from said at least one first loudspeaker, destructively interferes with said first ambient noise;
a noise cancelling speaker slave device;
wherein said noise cancelling speaker slave device comprises: at least one slave loudspeaker, which is configured to be in communication with said first active noise cancelling module; and at least one slave microphone, which is configured to be in communication with said first active noise cancelling module, and which is configured to sense and measure a slave ambient noise;
wherein said first active noise cancelling module processes said slave ambient noise to create a slave negative output audio;
wherein said slave negative output audio is configured to be projected from said at least one slave loudspeaker; and
wherein said slave negative output audio, when projected from said at least one slave loudspeaker, destructively interferes with said slave ambient noise;
wherein said noise cancelling speaker slave device is configured to be in communication with said first noise cancelling speaker, such that they work together to destructively interfere with said first ambient noise and slave ambient noise.

11. The noise cancelling system of claim 10, wherein said first noise cancelling speaker is physically connected to said noise cancelling speaker slave device.

12. The noise cancelling system of claim 10, wherein said first noise cancelling speaker is wire connected to said noise cancelling speaker slave device.

13. The noise cancelling system of claim 10, wherein said first noise cancelling speaker is wirelessly connected to said noise cancelling speaker slave device.

14. The noise cancelling system of claim 10, wherein said first noise cancelling speaker and said noise cancelling speaker slave device are configured to be engaged to or in one or more structures selected from the group of structures consisting of one or more of: a wall; a headboard; and
combinations thereof.

15. The noise cancelling system of claim 10:
wherein said first noise cancelling speaker further comprises:
at least one first adjustable loudspeaker base; and
at least one first adjustable microphone base;
wherein said at least one first loudspeaker is mounted on said at least one first adjustable loudspeaker base;
wherein said at least one first microphone is mounted on said at least one first adjustable microphone base;
wherein said at least one first adjustable loudspeaker base is configured to be adjustable so as to adjust an angle of said at least one first loudspeaker, thereby adjusting said first negative output audio, such that said first negative output audio is configured to destructively interfere with said first ambient noise; and
wherein said at least one first adjustable microphone base is configured to adjust an angle of said at least one first microphone to improve sensing and measuring of said first ambient noise;
wherein said noise cancelling speaker slave device further comprises:
at least one slave adjustable loudspeaker base; and
at least one slave adjustable microphone base;
wherein said at least one slave loudspeaker is mounted on said at least one slave adjustable loudspeaker base;
wherein said at least one slave microphone is mounted on said at least one slave adjustable microphone base;
wherein said at least one slave adjustable loudspeaker base is configured to be adjustable so as to adjust an angle of said at least one slave loudspeaker, thereby adjusting said slave negative output audio, such that said slave negative output audio is configured to destructively interfere with said slave ambient noise; and
wherein said at least one slave adjustable microphone base is configured to adjust an angle of said at least one slave microphone to improve sensing and measuring of said slave ambient noise.

16. The noise cancelling system of claim 10, wherein said first ambient noise experienced by a user is substantially reduced when said first ambient noise is destructively interfered with by said first negative audio output; and
wherein said slave ambient noise experienced by a second user is substantially reduced when said slave ambient noise is destructively interfered with by said slave negative audio output.

17. The noise cancelling speaker of claim 10, wherein said first noise cancelling speaker is configured to receive an audio signal from one or more media sources and subsequently play said audio signal from said at least one first loudspeaker and said at least one slave loudspeaker.

18. The noise cancelling system of claim 10, wherein said first noise cancelling soundbar and said noise canceling speaker slave device is configured to be controlled by a control interface.

19. The noise cancelling system of claim 10, further comprising at least one external microphone, which is configured to sense and measure an external ambient noise;
wherein said at least one external microphone is configured to be in communication with first active noise cancelling module;
wherein said first active noise cancelling module processes said external ambient noise to create an external negative output audio;
wherein said external negative output audio is configured to be projected from said at least one first loudspeaker; and
wherein said external negative output audio, when projected from said at least one first loudspeaker, destructively interferes with said external ambient noise.

20. The noise cancelling system of claim 10, wherein said first noise controlling speaker is configured to be in communication with at least one external microphone, which is configured to sense and measure an external ambient noise;
wherein said at least one external microphone is configured to be in communication with first active noise cancelling module;
wherein said first active noise cancelling module processes said external ambient noise to create an external negative output audio;
wherein said external negative output audio is configured to be projected from said at least one first loudspeaker; and
wherein said external negative output audio, when projected from said at least one first loudspeaker, destructively interferes with said external ambient noise.

21. A noise cancelling system, comprising:
a first noise cancelling speaker;
wherein said first noise cancelling speaker comprises: at least one first loudspeaker; at least one first microphone, which is configured to sense and measure a first ambient noise; a first active noise cancelling module, which is configured to be in communication with said at least one first loudspeaker and said at least one first microphone; at least one first adjustable loudspeaker base; and at least one first adjustable microphone base;
wherein said first active noise cancelling module processes said first ambient noise to create a first negative output audio;
wherein said first negative output audio is configured to be projected from said at least one first loudspeaker; and
wherein said first negative output audio, when projected from said at least one first loudspeaker, destructively interferes with said first ambient noise;
wherein said first noise cancelling speaker is configured to be engaged to or in one or more structures selected from the group of structures consisting of one or more of: a wall; a headboard; and combinations thereof;
wherein said at least one first loudspeaker is mounted on said at least one first adjustable loudspeaker base;
wherein said at least one first microphone is mounted on said at least one first adjustable microphone base;
wherein said at least one first adjustable loudspeaker base is configured to be adjustable so as to adjust an angle of said at least one first loudspeaker, thereby adjusting said first negative output audio, such that said first negative output audio is configured to destructively interfere with said first ambient noise; and
wherein said at least one first adjustable microphone base is configured to adjust an angle of said at least one first microphone to improve sensing and measuring of said first ambient noise.

22. The noise cancelling system of claim 21, wherein said first ambient noise experienced by a user is substantially reduced when said first ambient noise is destructively interfered with by said first negative audio output.

23. The noise cancelling system of claim 21, wherein said first noise cancelling speaker is configured to receive an audio signal from one or more media sources and subsequently play the audio signal from said first loudspeaker.

24. The noise cancelling system of claim 21, further comprising at least one external microphone, which is configured to sense and measure an external ambient noise;
wherein said at least one external microphone is configured to be in communication with first active noise cancelling module;
wherein said first active noise cancelling module processes said external ambient noise to create an external negative output audio;
wherein said external negative output audio is configured to be projected from said at least one first loudspeaker; and
wherein said external negative output audio, when projected from said at least one first loudspeaker, destructively interferes with said external ambient noise.

25. The noise cancelling system of claim 21, wherein said first noise cancelling speaker is configured to be in communication with at least one external microphone, which is configured to sense and measure an external ambient noise;
wherein said at least one external microphone is configured to be in communication with first active noise cancelling module;
wherein said first active noise cancelling module processes said external ambient noise to create an external negative output audio;
wherein said external negative output audio is configured to be projected from said at least one first loudspeaker; and
wherein said external negative output audio, when projected from said at least one first loudspeaker, destructively interferes with said external ambient noise.
